(19) United States
(12) Patent Application Publication
(10) Pub. No.: US 2013/0085782 A1
(43) Pub. Date: Apr. 4, 2013

(54) SYSTEM AND METHOD FOR PROVIDING ON-LINE MOVING INSURANCE

(71) Applicants: Boaz Raviv, New York, NY (US); Itzhak Raviv, Tel Aviv (IL)

(72) Inventors: Boaz Raviv, New York, NY (US); Itzhak Raviv, Tel Aviv (IL)

(21) Appl. No.: 13/252,161

(22) Filed: Oct. 3, 2011

(51) Int. Cl. G06Q 40/00

(52) U.S. Cl. 705/4

(57) ABSTRACT

A system and method for providing moving insurance according to an automatically generated quote.

### FIELD OF THE INVENTION

The present invention is of a system and method for providing moving insurance, and in particular but not exclusively, to such a system and method for providing automatic on-line quotes for such moving insurance and optionally also for claims handling.

### BACKGROUND OF THE INVENTION

Insurance is an important service, for example for covering various types of losses. Among the potential losses which may be covered by insurance are losses which occur as a result of moving. By “moving” it is meant that one or more physical objects, such as for example household goods, are transported from a first location to a second location (and optionally to further location(s) as well). During such transport, or optionally during storage as part of the moving process or even as one of the locations during the moving process, losses may occur, for example through physical damage to a physical object or even through complete loss of such an object (for example through theft or misplacement of the object).

Insurance to protect against such losses is typically referred to as “moving insurance”. Currently those who seek moving insurance are required to manually obtain such insurance, for example through telephonic communication with an insurance agent. Unfortunately it is currently not possible to obtain such moving insurance through a non-manual process.

Certain types of insurance, such as automobile insurance, may be obtained on-line, for example through a web page or otherwise through the Internet. However, automobile insurance is a relatively simple product to price, as rates are set according to the characterization of a single physical object (an automobile) and also one or more details regarding the user (such as age, gender, traffic records) and so forth.

Moving insurance, by contrast, involves the interaction of multiple actors (the owner of the goods to be protected, a moving company or professional mover performing the move) and a complicated set of a plurality of physical goods, for a limited time period as defined by the move itself.

No solutions have been proposed to these complicated factors. For example, solutions are available to assist human agents perform their functions, as described for example in U.S. Pat. No. 5,903,873, which provides a back office system for insurance agents. Other solutions are available for determining risk associated with a single location, as for example in US 2006/100912. However no solution is able to consider the above complicated factors.

### SUMMARY OF AT LEAST SOME ASPECTS OF THE INVENTION

The background art does not teach or suggest a system and method for providing on-line moving insurance quotes. The background art also does not teach or suggest a system and method for automatically providing on-line quotes and claims handling for moving insurance in transit and storage.

The present invention overcomes these drawbacks of the background art by providing, in at least some embodiments, a system and method for providing on-line moving insurance according to an automatically generated quote, optionally also featuring automated handling of claims.

By “moving insurance” it is meant any type of insurance for covering one or more physical goods in transit, optionally also including storage for household goods and personal effects, optionally including one or more vehicles such as an automobile, boat, motorcycle and so forth. By “in transit” or “moving” it is meant the act of transporting one or more physical goods from a first location to at least a second location. By “in storage” it is meant that following at least a first part of the transit, one or more physical goods from a first location is placed in storage; optionally after being placed in storage, the one or more physical goods are then transported to a second location.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, including, but not limited to, a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, any type of mobile device, a PDA (personal digital assistant), a pager, or a tablet. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1C show exemplary, illustrative non-limiting methods for providing moving insurance quotes according to an automatically generated quote according to at least some embodiments of the present invention;

FIG. 2 shows an exemplary, illustrative non-limiting system according to some embodiments of the present invention;

FIG. 3 shows an exemplary, illustrative non-limiting GUI (graphical user interface) dashboard for an underwriter according to some embodiments of the present invention;

FIGS. 4A and 4B relate to exemplary, illustrative, non-limiting methods for providing details about contents to be moved, optionally also with regard to any new contents and associated insurance coverage thereof, according to at least some embodiments of the present invention;

FIG. 5 shows an exemplary, illustrative non-limiting method for determining a statistical basis for moving insurance as determined according to the mover, and optionally also according to the category and/or type of goods to be moved and/or also according to the start and end point(s) of the move, according to at least some embodiments of the present invention;

FIG. 6 shows an exemplary, illustrative non-limiting method for implementing one or more heuristics for at least partially determining moving insurance as described with regard to FIGS. 1 and 2, according to at least some embodiments of the present invention; and

FIG. 7 shows an exemplary, illustrative non-limiting method for recommending a mover according to at least some embodiments of the present invention.

### DESCRIPTION OF THE PREFERRED EMBODIMENTS

The present invention is, in at least some embodiments, of a system and method for providing moving insurance according to an automatically generated quote.

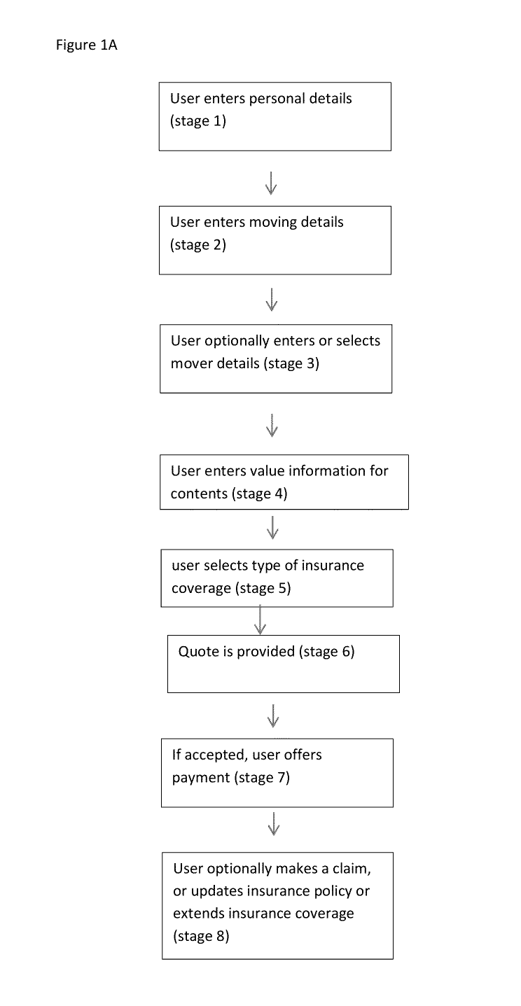

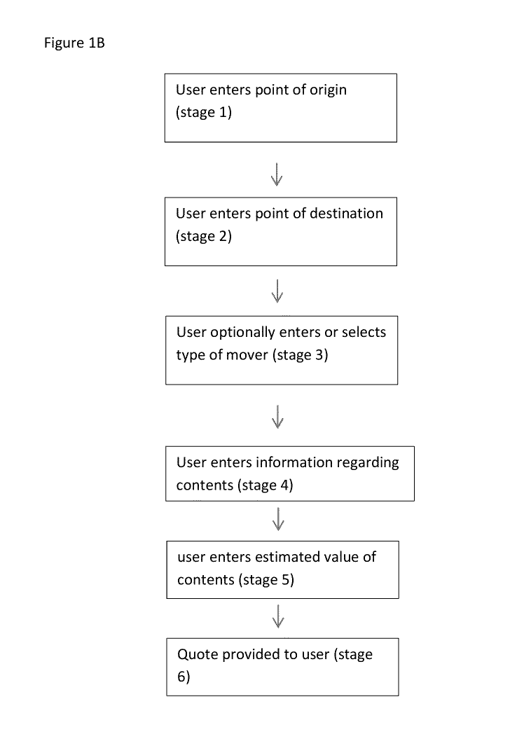

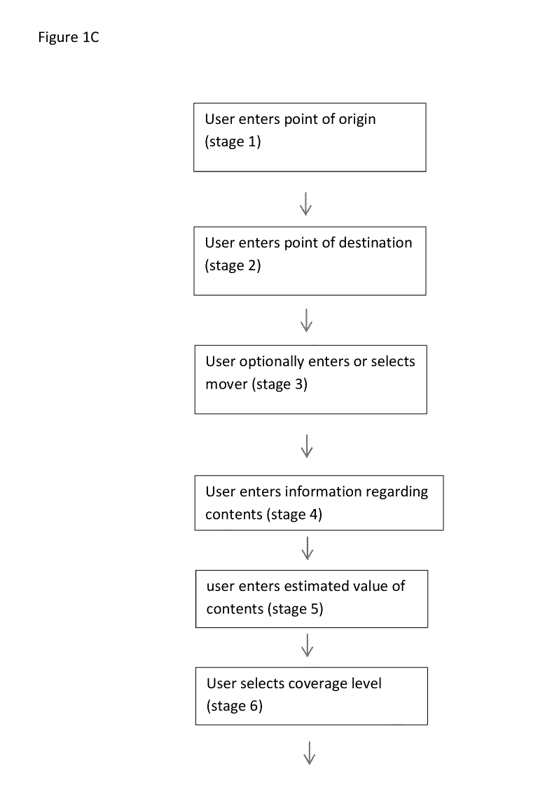

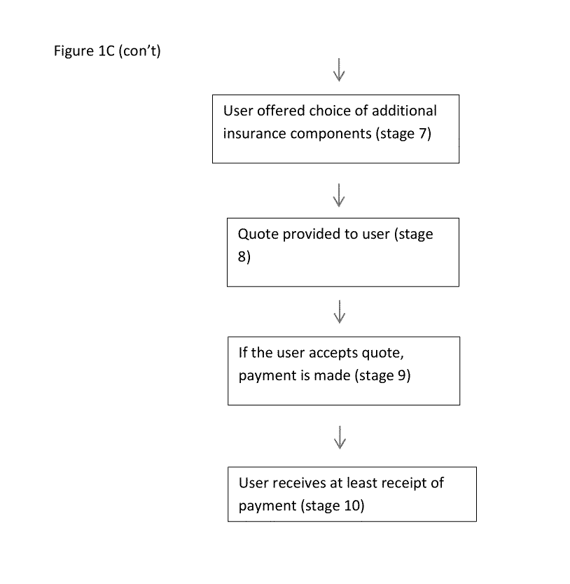

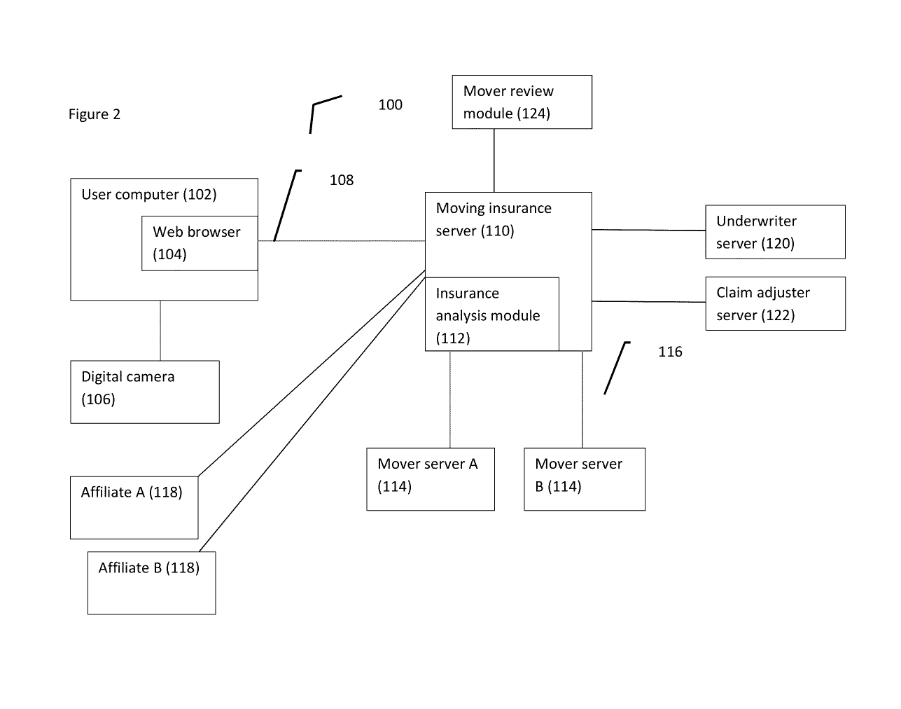

Referring now to the drawings, FIGS. 1A-1C show exemplary, illustrative non-limiting methods for providing moving insurance according to an automatically generated quote according to at least some embodiments of the present invention. The method as described herein is computationally based and is performed through the interaction(s) of a user with a user computer, which may also optionally be any type of computer as described herein, including but not limited to mobile device or tablet, as described in greater detail with regard the exemplary system of FIG. 2.

FIG. 1A relates to a general method for automatically obtaining a quote. As shown, in stage 1 a user optionally enters personal details through a user computer.

Such personal details optionally include one or more of a user name, physical address, email address, telephone number and so forth.

In stage 2, the user enters details of a move. The move relates to transporting one or more physical goods from a first location to at least a second location; optionally the first location may comprise a plurality of locations. The details to be entered optionally include at least the first and second location(s) for the move, preferably with a detailed address for each such location. Optionally and preferably, a time period during which the move is expected to occur is also entered, for example giving a start date for initial preparation by the moving company (for example, packing); optionally an expected end date for completion of the move, although this is not required. Preferably one or more user details are also entered if not entered in stage 1, although optionally at least an initial quote may be generated without such user details. The details are preferably entered through a website, wizard or other software interface (described herein as a “user software interface”).

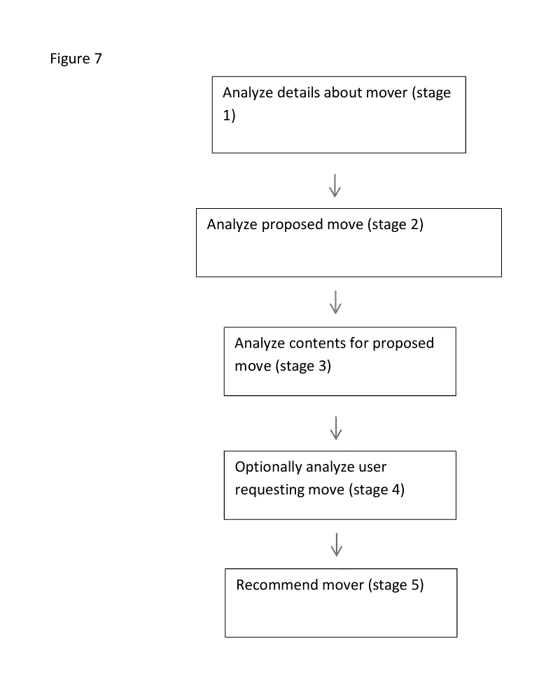

In stage 3, the user optionally enters or selects a mover (which as described below may also optionally include the possibility of self service). For example, the user software interface may optionally provide a list of one or more movers from which the user may select a mover. The list may optionally be provided according to one or more of the details of the move, details of the contents or a combination thereof, as described in greater detail with regard to the exemplary method of FIG. 7 below. Alternatively or additionally, the user may enter the name of a mover that the user wishes to use for the move.

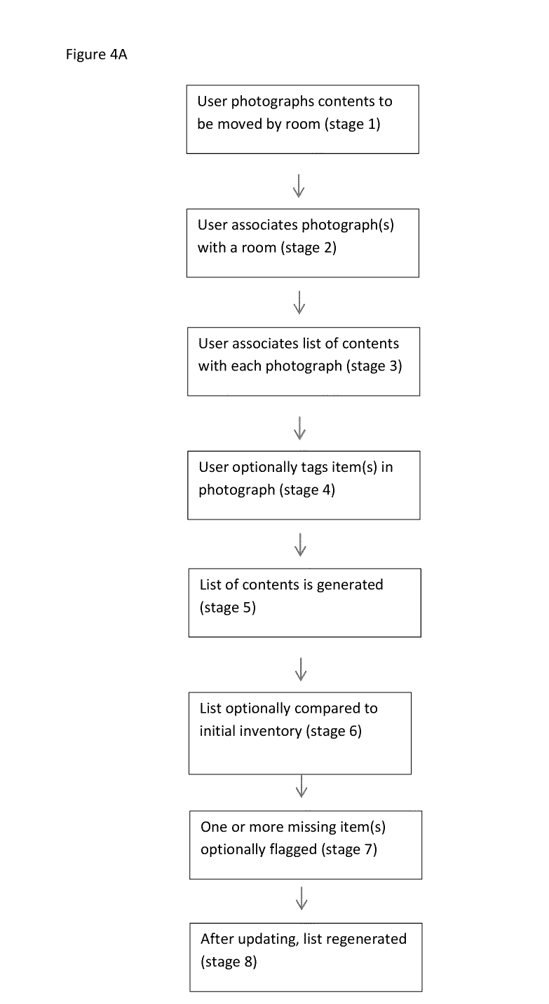

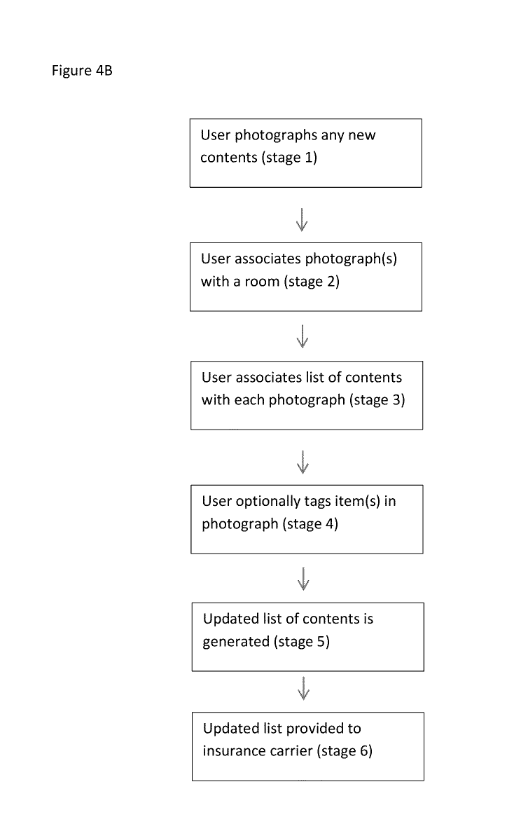

In stage 4, the user enters value information for the contents to be moved. Optionally the user may enter a lump sum request; if not, then the user is requested to add details regarding the contents, optionally by name, by value, by image or a combination thereof. By “contents” it is meant one or more physical goods. The details preferably include at least a list of the contents, more preferably including one or more descriptors of the goods at least by category, most preferably with one detailed descriptors of the goods. For example, the list may optionally include one or more items of furniture, which are preferably further described by category (“sofa”, “table”, “bed” and so forth) and which more preferably have one or more other detailed descriptors associated with them (for example and without limitation, the manufacturer or brand of each item of furniture, any known valuation information, any information on the condition of each item of furniture and so forth). As described with regard to FIG. 4A, optionally and preferably the user provides one or more photographs of the contents to be moved through the user software interface.

In stage 5, the user selects the type of insurance to be provided. The type of insurance may optionally feature comprehensive loss coverage or coverage that is limited in some manner, for example according to the amount and/or type of losses covered. The type of insurance may optionally exclude a certain part of the move, for example with regard to a certain type of transport used or to a segment of the transport process. The type of insurance may also optionally exclude certain goods or otherwise cap the coverage to be provided.

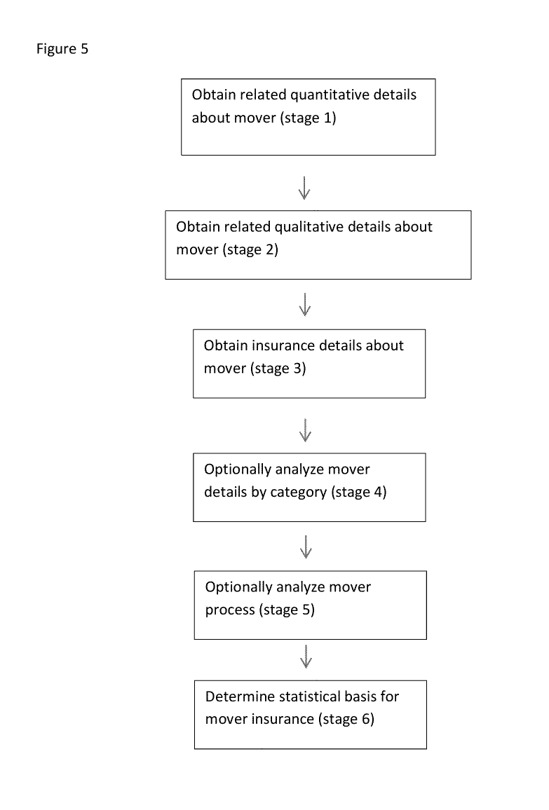

In stage 6, the received information is analyzed for determining the insurance quote. The analysis is preferably performed according to a combination of a statistical basis for determining moving insurance quotes for the specified mover and for the details of the move, and the details of the contents to be insured. The statistical basis for the mover and the details of the move may optionally be determined according to the exemplary method of FIG. 5. Alternatively a basic level of insurance quote is determined without specific analysis of the mover and any associated losses and/or such losses are considered only with regard to a basic raise in the premium and hence in the quote. The basic level insurance quote preferably relates to at least the contents to be covered and geographical and/or transport aspects of the move.

In stage 7, if the user accepts the quote, then the user preferably may request to purchase additional coverage and thereafter provides payment, for example through a credit card, bank transfer, and/or electronic funds transfer of any type. At this stage, if the user has not already done so in stage 1, the user preferably provides user details, including but not limited to, name, address, telephone number, email address and so forth.

In stage 8, once the move has been performed or optionally during the move, the user makes a claim against the insurance for any type of loss or damage to the contents. Since the system has already received the contents of the move, in a very simplified and user friendly process, the user preferably enters, for example by simply clicking in a check box, the items for which the user wishes to file a claim, along with a brief description of such claim and an option to upload pictures of the object upon which the claim is based. As described in greater detail below, the user may also optionally (alternatively or additionally) choose to upgrade or add insurance, for example to protect household goods in their location after the move. The user may also optionally, additionally or alternatively, request to extend coverage, for example if delays occur during the move, as the moving insurance may optionally be provided for a limited period of time.

FIG. 1B shows an exemplary method for obtaining a rapid insurance method according to at least some embodiments of the present invention. As shown in stage 1, the user enters a point of origin for the move. In stage 2, the user enters a point of destination for the move. Optionally, one or more intermediate parts of the move may also be indicated, for example optionally including storing at least a portion of the contents to be moved in a storage facility before transporting such stored contents to a final destination.

In stage 3, the user optionally enters or selects a type of mover. By “mover” it is meant any moving provider. Non-limiting examples of such types of mover include Full-Service (such movers typically perform all aspects relating to the moving process, including but not limited to pack/unpack, load/unload, and actual physical transport of the contents); Half-Service (typically the customer will perform at least part of the moving process, for example including the processes of packing/unpacking, loading/unloading, while the mover will perform actual physical transport of the contents); Vehicle Transport movers (Motor Vehicles and Watercraft only); and Self-Service (the customer performs the entire moving process). Optionally the user may be limited with regard to the type of mover; for example, the user may be required to select a full service mover. Optionally, self service moving insurance is not available.

In stage 4, the user preferably enters information regarding the contents to be moved and for which insurance coverage is to be purchased. Non-limiting examples of such contents include categories such as household goods, personal effects, motor vehicles and watercraft, or a combination of any of these categories.

In stage 5, the user preferably enters an estimated value for the contents to be moved. Optionally, stages 4 and 5 are combined to a single stage. In stage 6, a rapid insurance estimate is generated and provided to the user, for example by being displayed on the user computer or transported to a mobile device or otherwise indicated to the user.

FIG. 1C shows an exemplary method for obtaining a detailed insurance method according to at least some embodiments of the present invention. As shown, stages 1 and 2 are similar to stages 1 and 2 of FIG. 1B.

In stage 3, the user optionally selects a mover (which as described below may also optionally include the possibility of self service). Various optional implementations for this stage are possible. For example, optionally the user may select from the previously described types of movers (full service, half service, vehicle transport or self service). Optionally, additionally or alternatively, the user may select a conveyance type, for example including but not limited to one or more of land transport (motor vehicle such as a truck or a train); sea transport, such as a ship; or air transport such as an airplane. Also optionally, additionally or alternatively, the user may enter or select a specific mover, preferably with mover details, whether manually or from a database or through an auto-completion process.

The user may also optionally enter the above information in multiple stages; for example, starting by indicating a type of mover and/or conveyance, and then receiving one or more suggestions for a specific mover as displayed on the user computer.

In stage 4 the user enters information about contents, optionally and preferably at least including a type of contents (household goods, personal effects, motor vehicles/watercraft) as previously described but more preferably also including some type of inventory list. As described in greater detail below, the inventory list may optionally be a standard list of itemized goods and/or may also optionally feature one or more images of the goods to be protected. Also optionally, the contents may be itemized by type; for example for household goods, the contents may optionally be grouped or labeled by room (living room, kitchen, bedroom etc) and/or by category (furniture, electronic goods etc). Alternatively rather than providing a detailed list, the user may optionally skip this step and only indicate a lump sum of desired coverage in stage 5 below.

In stage 5, the user enters an estimated value of contents. The value may optionally be provided as a lump sum as described above or alternatively may optionally be provided in an itemized manner for each item or group of items separately. For example, a value may optionally be provided for a group or category of goods (items).

In stage 6, the user selects a desired level of coverage. For example, the level of coverage optionally relates to the types of loss and/or risk, and also preferably relates to the amount of deductible. Optionally the user may be asked to select from an itemized list of risk coverage (theft, damage, misplacement). Alternatively, the user may select from various combinations or packages of risk coverage.

In stage 7, the user may optionally be provided with a choice of coverage add-ons (additional components). For example the user may optionally be provided with a list of coverage additional components, such as “pairs and sets” coverage, in which a user may be compensated for the need to purchase an entire set or pair of goods if one is damaged, stolen or lost (as opposed to only providing coverage for the single damaged, stolen or lost item); minor damage coverage, in which an item is otherwise usable but has been aesthetically damaged; Mechanical and Electrical Derangement, whereby an electrical and/or mechanical item ceases to function upon arrival at destination even though there are no visible signs of damage to the item; and/or reduction in value coverage, in which the user is compensated for a reduction in potential future value (such as for antiques, art and other valuables with a value that may be expected to increase in the future). Optionally the user may only be offered such additional coverage if at least a minimal level of insurance is purchased.

In stage 8, after the user has selected a level of coverage (optionally with one or more additional components), a quote is provided to the user, optionally as previously described.

Optionally, the order of stages 7 and 8 may be reversed.

In stage 9, if the user accepts the quote, the user makes payment (for example as described with regard to FIG. 2). Optionally before payment is made, the details of the quote are displayed again, preferably so that the user is required to accept them to make payment or effectively accepts them by making payment. If the user does not accept the quote, then optionally the process returns to an earlier stage and is repeated.

In stage 10, once payment is made, the user optionally receives at least a receipt of payment. However, preferably different items are provided to the user according to the type of coverage requested. For example, for insurance of household goods and/or personal effects, the user preferably receives a copy of the insurance policy and/or certificate, a description of terms and conditions for the policy, a description of the details of the move (optionally with an inventory list if provided) and a receipt of payment; optionally transportation details are also included. For insurance of motor vehicles/watercraft, optionally the user also receives a motor vehicle/watercraft condition form (which is then preferably completed and signed at least by the mover and also optionally by the user). These items may optionally be received at the user computer through downloads and/or email messages, for example.

FIG. 2 shows an exemplary, illustrative non-limiting system according to some embodiments of the present invention. As shown, a system 100 features a user computer 102 for being operated by a user, which has a user software interface 104, which in this non-limiting example comprises a web browser, although of course other implementations are possible. As described with regard to FIG. 1, the user interacts with system 100 to enter information and to receive a quote, and optionally also to make a payment, through user computer 102 and more particularly through user software interface 104. Information is also preferably displayed to the user through user software interface 104, for example through a web browser, email client and so forth. Optionally user software interface 104 may feature a plurality of different types of applications, such as for example a web browser and also an email client.

User computer 102 optionally and preferably comprises, or is in communication with, a digital camera 106. By “in communication with” it is meant that one or more photographs may preferably be uploaded from digital camera 106. The type of connection between digital camera 106 and user computer 102 is not a limiting factor for their interaction; for example such a connection may optionally comprise one or more of a direct connection to user computer 102 (wired or wireless), a direct connection of a portion of digital camera 106 (such as a memory stick for example) or an indirect connection between digital camera 106 and user computer 102 (for example through a computer network of some type).

User computer 102 is preferably in communication with a moving insurance server 110 through a computer network 108, which may optionally be the Internet for example. Moving insurance server 110 may optionally be implemented as a plurality of computers, virtual or actual, for example as a server farm. The interactions with the user, described in FIGS. 1A-1C, for at least generating an automatic insurance quote, preferably occur through communication between user computer 102 and moving insurance server 110. Moving insurance server 110 preferably provides a quote and optionally also documents as described with regard to FIG. 1C. More specifically, moving insurance server 110 preferably features a plurality of software modules for supporting such communication as described in greater detail below.

Moving insurance server 110 preferably features an insurance analysis module 112 for performing the necessary analysis to automatically generate the moving insurance quote, for example optionally as described in greater detail with regard to the non-limiting examples of FIGS. 1, 5 and 6. Such analysis preferably relates to details about the move (start and endpoints for example), the contents to be protected, the type of mover (full service vs. only partial service), a claims history for the mover if available and so forth.

As described for example with regard to FIG. 1, the user preferably interacts with user computer 102 to enter at least details about the move through user software interface 104. More preferably, details about the contents are also entered through user software interface 104. For example and without limitation, a list of rooms could optionally be provided through user software interface 104; the user could then optionally select one or more rooms with regard to the contents. Once a room has been selected, user software interface 104 could optionally provide a list of items typically associated with such a room, including but not limited to furniture, electronic goods, clothing, decorative items and so forth. The user could optionally select one or more items; preferably, the user also uploads one or more photographs through the interaction of digital camera 106 with user computer 102 as previously described.

Optionally, after the user provides one or more photographs, the user is able to label each photograph with one or more tags, describing the items shown in each photograph. Such interactions are preferably performed through user software interface 104. Furthermore, the user may also optionally enter a price for each item and/or rely upon a standard price given for a particularly type of item, again preferably through user interface 104.

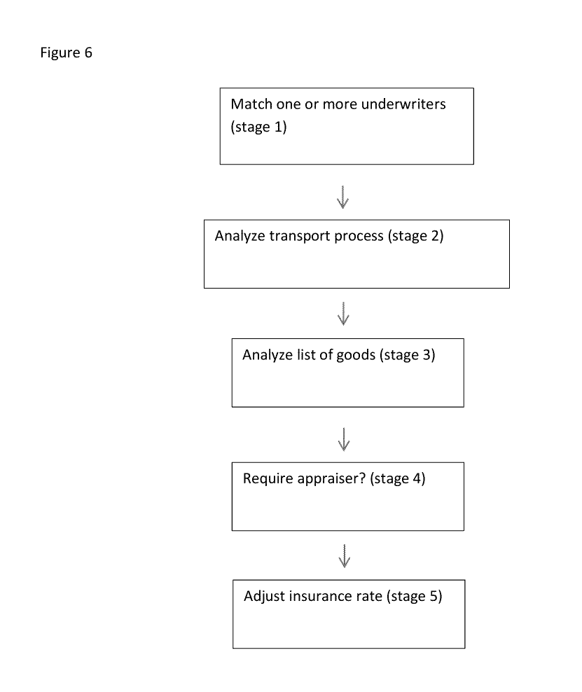

Once the contents and the move have been described and/or otherwise provided through user software interface 104, details regarding the contents and the move are preferably transmitted to moving insurance server 110 through computer network 108. Moving insurance server 110 then preferably automatically calculates a quote (more preferably the calculation is provided by insurance analysis module 112 as previously described), optionally according to the exemplary methods of FIGS. 5 and 6. In order to receive information regarding premiums and optionally any geographical or other limitations of underwriters, moving insurance server 110 is preferably in communication with at least one underwriter server 120 as shown, and more preferably is in communication with a plurality of such underwriter servers 120 (not shown). Moving insurance server 110 may optionally receive such information periodically, for a given set of conditions or terms, or alternatively (or additionally) may optionally request quote information in real time for a particular user request from one or more underwriter servers 120.

If the user has not indicated or selected a particular mover, moving insurance server 110 optionally provides information regarding one or more movers, for example according to the exemplary method of FIG. 7. Providing such information may optionally encompass providing a list of movers and/or autocompleting a mover name; it may also optionally encompass recommending a particular mover and/or providing a “short list” of a plurality of movers from which one may be selected by the user. Such information may optionally be provided by a mover review module 124, which may optionally provide the information to server 110 as shown or alternatively may provide such information directly to user interface 104 through user computer 102 (not shown). Mover review module 124 preferably determines such information according to the exemplary method of FIG. 7. Payment is also optionally handled through moving insurance server 110.

Moving insurance server 110 may also optionally be in contact with one or more mover servers 114, shown as mover servers A and B 114 for the sake of illustration only and without any intention of being limiting, through any type of computer network 116. For example, moving insurance server 110 may optionally receive quantitative information about a mover through such mover server 114.

Moving insurance server 110 may also optionally transmit and/or receive claim information about a user claim from such mover server 114 and/or through an interaction of the user with a user computer 102.

For example, the user could interact with a web browser operated by user computer 102 (again optionally through user software interface 104), for example to select an option to file and/or view a claim, optionally through a policy management option. To file such a claim, the user may optionally be required to enter the email address associated with the policy, preferably with some type of identifier, such as a password and/or certificate key number (a randomly generated number when the policy was first issued). Upon accessing the interface to file a claim, the user is preferably asked (through the web browser) to provide a general description of the nature of the claim, as well as highlight any item from the inventory that has sustained damage or loss.

If as described below, an itemized inventory was provided by the user, moving insurance server 110 may optionally provide a list to the user through user computer 102, such that the user is only required to select one or more items on which a claim is to be made. Optionally, to show a current condition of an item, the user may be requested or required to upload a current image through user computer 102.

In any case, preferably once information has been provided from the user (more preferably through user computer 102) and/or from the mover (more preferably through mover server 114), a claim adjuster server 122 preferably receives such information from moving insurance server 110. Claim adjuster server 122 then calculates any loss and optionally determines whether any further information is to be received in order for the claim to be processed.

Moving insurance server 110 may also optionally be in contact with one or more affiliates 118, again through any type of computer network 116 (which may optionally be the same or a different computer network). A plurality of affiliates 118 is shown for the sake of discussion and without any intention of being limiting, as affiliate A 118 and affiliate B 118. Affiliate A 118 may optionally be an insurance broker or agent for any type of insurance. However, rather than handling the moving insurance quote on behalf of a client, each client is preferably recommended by affiliate A 118 to interact with a user computer 102 for obtaining the quote automatically and electronically through moving insurance server 110.

Affiliate B 118 may optionally be another mover, which recommends clients to obtain insurance through an interaction with a user computer 102 and moving insurance server 110 as previously described. Optionally a client referred by such an affiliate 118 would receive more favorable conditions, such as a lower price for example.

Optionally each of Affiliates A and B 118 receives a payment for referring one or more clients to obtain insurance through system 100 as described herein.

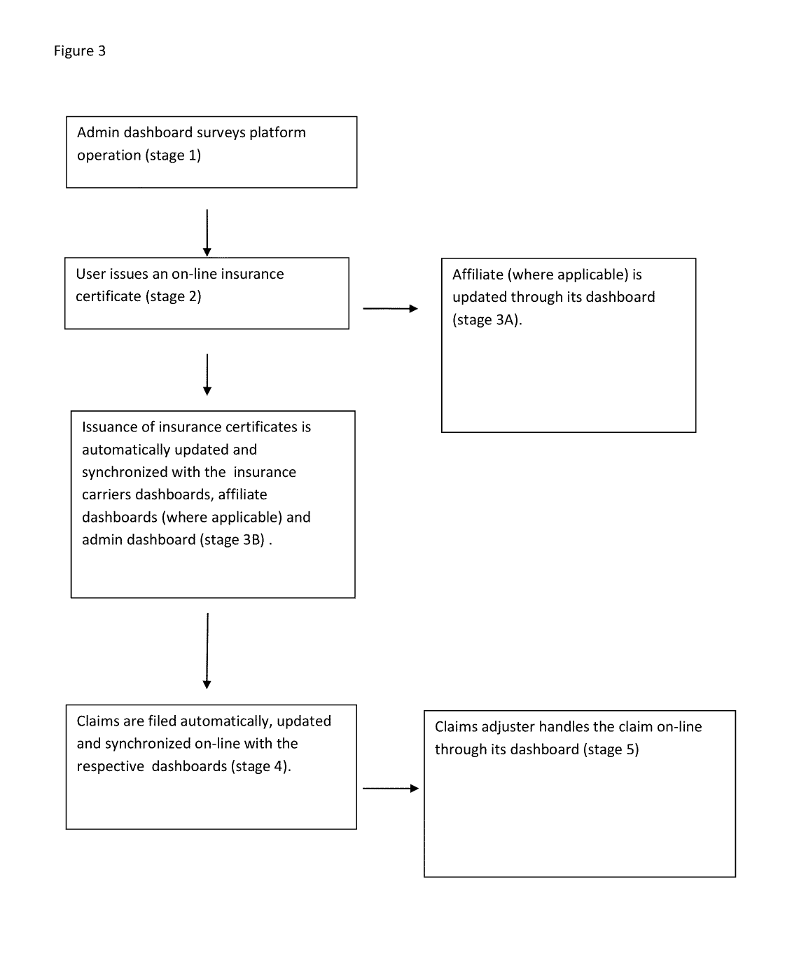

FIG. 3 shows an exemplary, illustrative non-limiting method for process control according to some embodiments of the present invention. As shown in stage 1, a dashboard preferably features a plurality of information display sectors and is used for administration purposes as an “admin” dashboard. Although the dashboard activity is stated to occur in stage 1, in fact it preferably occurs throughout the insurance process, such that stage 1 preferably continues during execution of the other stages as the admin overview function continues. Each information display sector may optionally feature any type of suitable display, including but not limited to a numerical display, a graph, a word description or any combination thereof. Preferably the dashboard features at least the following information display sectors (described according to the type of information provided): geographical area(s) covered by actual underwritten policies, geographical area(s) covered by rejected (not underwritten) policies, claim rate (per amount insured, premiums paid, particular mover and/or number of policies insured), average amount insured, type of goods insured and so forth.

Optionally similar dashboard GUIs may be provided for claim adjusters and/or moving companies and/or affiliates (not shown).

In stage 2, the user issues an on-line insurance certificate by directly completing all steps through a website or other interactions with the previously described moving insurance server; alternatively, the user may optionally only complete a portion of the steps after an affiliate has already pre-filled a portion of the steps through an affiliate referral as previously described.

In stage 3A, the affiliate (where applicable) is updated through its dashboard on the status of the user with respect to the issuance of the insurance certificate and any marketing fee or commission (where applicable) due to the affiliate.

In stage 3B, issuance of insurance certificates is automatically updated and synchronized with the insurance carriers' dashboards, affiliate dashboards (where applicable) and the previously described admin dashboard of stage 1, with all accompanying information relating to such insurance certificates and status. Insurance carriers are preferably able to access relevant data and statistical information on-line, through the previously described server arrangement of the system of FIG. 2 for example.

In stage 4, claims are filed automatically, updated and synchronized on-line with the respective dashboards as previously described, for example preferably including the insurance carrier dashboard, claims adjuster dashboard, affiliate (where applicable) dashboard, and the admin dashboard with accompanying information relating to such claim.

In stage 5, the claims adjuster handles the claim on-line through its dashboard. All actions executed on behalf of claims adjuster are optionally and preferably automatically updated and synchronized with the previously described dashboards.

FIGS. 4A and 4B relate to exemplary, illustrative, non-limiting methods for providing details about contents to be moved, optionally also with regard to any new contents and associated insurance coverage thereof, according to at least some embodiments of the present invention. The methods of FIGS. 4A and 4B are performed computationally, for example and without limitation through the system of FIG. 2. Interactions or actions described below as being made by the user are assumed to be made through a user computer, mobile device, tablet (and/or digital camera as appropriate).

As shown with regard to FIG. 4A, which relates to an exemplary method for determining a list of contents to be moved (and for which the moving insurance quote is to be obtained), in stage 1 the user optionally and preferably photographs the contents to be moved. Although not necessary, preferably the user photographs the contents before they are packed or otherwise prepared for moving, more preferably by room. The photographs are then uploaded or otherwise provided to the moving insurance server as described with regard to FIG. 2.

In stage 2, the user associates one or more photographs with a room, for example by selecting from a preset list (which for example may optionally comprise such typical rooms as “kitchen”, “living room”, “bedroom” and so forth) and/or by adding a manual descriptor to describe a room. The manual descriptor may optionally be added to a general room descriptor (i.e.—“baby's bedroom”) or may alternatively be generated completely manually. Optionally the photographs may be taken for each room, rather than for each item (or a smaller set of items) separately, after which the items in the room are labeled.

In stage 3, the user optionally and preferably associates a list of one or more content items (list of contents) with each photograph. The list may for example relate to items of furniture or any of the previously described categories, and may also optionally feature one or more specific descriptors, for example according to brand name, condition, value and so forth as previously described. In stage 4, the user optionally and preferably tags one or more items in each photograph, thereby labeling a sofa with the word “sofa” and so forth. Again, each tag may also optionally feature one or more specific descriptors as previously described. The tags may optionally be selected from a list that is suitable for a particular room category (for example, offering “sofa”, “chair”, “table” and so forth for a living room) and/or may optionally be generated partially or completely manually.

Optionally and preferably, next to each tag user inserts a price value for the tagged item. Also optionally, a single type of tag may be labeled with a value which is then automatically associated to all items having that tag.

In stage 5, optionally during but preferably after the user has uploaded all photographs and has performed the above stages to determine the contents to be moved, a list of contents is automatically generated. The user may optionally review the list and may optionally make one or more manual changes, and/or may optionally return to any of the above stages in the process to partially or completely alter the list.

In stage 6, the list may optionally be compared to any initial inventory, whether a typical generic inventory, one provided by an affiliate (such as an insurance agent providing a housing insurance policy to the user) or one that the user generated initially (for example, in order to obtain an initial quote). In stage 7, optionally the two lists are compared to determine whether any item(s) are missing. If the final list has any missing items or items that should be adjusted, again the user may optionally do so. After updating, in stage 8 the list is generated again.

FIG. 4B relates to an exemplary method for using the generated list of contents from FIG. 4A as a basis to optionally prepare a list of contents for obtaining household insurance or for other purposes after moving is complete. For example, as described below, the user may optionally use such a list to obtain house contents insurance and/or to update such insurance. In stage 1, the user optionally photographs any new contents and/or rooms in the new location (the latter may optionally be performed even if the contents are not new). Optionally the photographs may be taken for each room, rather than for each item (or a smaller set of items) separately, after which the items in the room are labeled. Stages 2-4 are performed as for FIG. 4A.

In stage 5, an updated list of contents is generated, based upon the new location of the items and also optionally based on the presence of one or more new and/or replacement items. In stage 6, the updated list is optionally provided or automatically integrated to a respective insurance carrier and/or to any other entity requiring or desiring such an updated list of household contents. For example, the list may optionally be generated at the moving insurance server and optionally sent directly to an insurance carrier for non-moving insurance (for example, for household contents insurance).

FIG. 5 shows an exemplary, illustrative non-limiting method for determining a numerical basis for moving insurance as determined according to the mover, and optionally also according to the category and/or type of goods to be moved and/or also according to the start and end point(s) of the move, according to at least some embodiments of the present invention.

As shown, in stage 1, quantitative details about the mover are obtained. Such details may optionally relate to geographical area covered, average moving load value, high and low moving load values, distribution of moving load values, type and/or category of items moved (preferably including whether such items are fragile, of high value (above a threshold amount) and so forth).

Optionally if such details are not known, then in place of these details various assumptions about the mover are made instead, according to a standard risk assessment, assuming the same point of origin and destination, mover type, method of shipment, and type of contents.

In stage 2, qualitative details about the mover are obtained. Such details may optionally relate to one or more of customer satisfaction (whether determined through numerical ratings, qualitative word reviews or a combination thereof), peer review from other movers, employee ratings, or third party ratings (Better Business Bureau, Yelp and so forth), or a combination thereof. Customer satisfaction may include moving company's timeliness, professionalism, accuracy of moving cost estimate relative to final price (for example, not excessively increasing the final price over the initial estimate), etc. Additionally, other non-quantitative factors that could determine the moving company's rating are: number of years in business, Dun and Bradstreet reports, if available, quality of moving company's website and so forth.

In stage 3, insurance details about the mover are obtained, including but not limited to one or more of number of claims (optionally total and/or within a particular time period), rate of claims (optionally per number of loads moved and/or time period), total cost of claims (optionally total and/or within a particular time period), average cost of claims (optionally per time period).

In stage 4, optionally and preferably one or more of the details obtained in any of stages 1-3 are analyzed with regard to the type of load, one or more load parameters (value of goods, whether such goods could be considered to be “delicate” and so forth), the distance moved, type of transport required and/or start and/or end locations.

In stage 5, optionally and preferably one or more internal processes of the mover are analyzed, for example with regard to safety measures, precautions taken for delicate and/or expensive goods (for example with regard to security, protection against breakage or other types of spoilage and so forth), customer relationship processes (for example to handle customer complaints) and so forth.

In stage 6, the results of stages 1-5 are preferably used to determine at least a numerical basis for the mover insurance, for example for use with regard to FIG. 1 or 2 as previously described. Such results may optionally be calculated according to any actuarial standards and/or risk analysis as is known in the art.

FIG. 6 shows an exemplary, illustrative non-limiting method for implementing one or more heuristics for at least partially determining moving insurance as described with regard to FIGS. 1 and 2, according to at least some embodiments of the present invention.

For example, optionally in stage 1, one or more potential underwriters are matched with a potential move according to the start and endpoints of the move. As many underwriters prefer to underwrite moving insurance according to a geographically limited area, it is possible that one or more underwriters would not be suitable for a particular policy.

In stage 2, the transport process itself is optionally analyzed. For example, it is possible to insure a shipment up to a seaport but not from the seaport to the final endpoint such as a house. Therefore optionally one or rules are applied to determine whether only part of the transport process is to be covered.

In stage 3, any tagged images of goods that are provided are analyzed (or alternatively a list of goods with price estimates is analyzed). Optionally such analysis determines whether there are any apparent discrepancies between the image and/or description of the goods and the price estimate for coverage. Also optionally other features of the collection of goods are analyzed, for example to determine whether more than an allowable maximum percentage of goods (or of coverage purchased) may be deemed to be fragile or breakable, and/or whether excluded goods are on the list for which coverage is requested (eg fine china, art, old books/letters, rugs and so forth).

In stage 4, the insurer (underwriter) may optionally require an appraiser a sales receipt for item(s) above a certain value level. If such an appraisal or sale receipt is not provided, then the goods may also optionally be excluded.

In stage 5, the insurance rate is optionally adjusted according to the type of contents and/or one or more items that are excluded, for example for the reasons given previously.

Stages 1-5 are preferably performed by the moving insurance server, for example as described with regard to the system of FIG. 1, optionally in communication with the previously described underwriter server. More preferably, stages 1-5 are performed automatically.

FIG. 7 shows an exemplary, illustrative non-limiting method for recommending a mover to a user according to at least some embodiments of the present invention. As shown, in stage 1, details about a plurality of movers are analyzed (for example as obtained with regard to the method of FIG. 6). These details preferably include measures of customer satisfaction, statistical or other analyses of breakage or other loss related to the move, parameters regarding on-time pick-up and/or delivery of the goods and so forth. The previously described moving insurance server may optionally receive and analyze such information from customers and/or movers; alternatively such information may optionally be received and analyzed by a separate server.

In stage 2, the proposed move by the user is analyzed, for example with regard to the type and/or category of contents (preferably including with regard to any special characteristics such as value or delicacy), the start and end location(s) of the move, and so forth. In stage 3, the contents themselves are preferably analyzed in more detail (such information may optionally be obtained with regard to the method of FIG. 4, for example). In stage 4, optionally the user requesting the move is analyzed, for example with regard to previous insurance claims (for moving insurance or otherwise), credit history and so forth. In stage 5, these results are preferably combined to recommend a mover (or optionally a plurality of movers) to the user.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for providing an automated moving insurance quote for a move, the method being performed by a plurality of computers in communication through a computer network, the stages of the method comprising: receiving a request from a user through a user computer for a moving insurance quote by a moving insurance server, the request comprising a start location for the move and an end location for the move, and a value of goods to be transported from said start location to said end location; automatically calculating a cost of said moving insurance according to said request by said moving insurance server; and automatically transmitting said cost as a quote to said user computer by said moving insurance server.

2. The method of claim 1, wherein said receiving said request comprises first transmitting said start location and said end location from said user computer to said moving insurance server; entering a list of goods to said user computer by the user; entering a value for a plurality of items in said list of goods to said user computer; and transmitting said values and said list of goods to said moving insurance server.

3. The method of claim 2, wherein said entering said list of goods comprises receiving said list of goods from a separate insurance server according to a previously provided insurance policy for said goods.

4. The method of claim 3, wherein said receiving said list of goods further comprises updating said list of goods by the user through said user computer.

5. The method of claim 2, wherein said entering said list of goods further comprises providing a plurality of photographs of a plurality of items in said list of goods to said user computer; and tagging said plurality of items by labeling said plurality of photographs through said user computer.

6. The method of claim 5, wherein said entering said value further comprises entering a value for each item tagged in said plurality of photographs.

7. The method of claim 6, wherein said automatically calculating said cost further comprises calculating said cost according to said values for said items.

8. The method of claim 7, wherein said entering said value further comprises entering a lump sum for a plurality of items shown in a single photograph and wherein said automatically calculating said cost further comprises calculating said cost according to said lump sum.

9. The method of claim 7, wherein said automatically calculating said cost further comprises automatically analyzing said list of goods by said moving insurance server to determine whether each associated price is below a maximum threshold.

10. The method of claim 9, wherein if an associated price is above said maximum threshold, said automatically analyzing further comprises rejecting said item having an associated price above said maximum threshold from being insured by said moving insurance server.

11. The method of claim 9, wherein if an associated price is above said maximum threshold, said automatically analyzing further comprises adding an additional cost to said premium.

12. The method of claim 7, wherein said automatically calculating said cost further comprises automatically analyzing said list of goods by said moving insurance server to determine whether an amount of items on said list that are fragile exceeds a maximum threshold.

13. The method of claim 12, wherein if said amount exceeds said maximum threshold, at least a portion of said items are rejected from being insured or said automatically analyzing further comprises adding an additional cost to said premium.

14. The method of claim 1, wherein said automatically calculating said cost comprises selecting an underwriter by said moving insurance server according to at least said start location and said end location.

15. The method of claim 14, wherein said receiving said request further comprises receiving an identity of a mover to perform said move from said user computer, and wherein said calculating said cost is at least partially performed according to said identity of said mover.

16. The method of claim 15, wherein said identity of said mover relates to a category of mover.

17. The method of claim 15, wherein said identity of said mover relates to a specific mover and wherein said calculating said cost is at least partially performed according to an analysis of a plurality of previous moves performed by said mover.

18. The method of claim 17, wherein said receiving said identity of said mover further comprises receiving a category of transportation for said move and wherein said calculating said cost is performed at least partially according to said category of transportation.

19. The method of claim 18, wherein said calculating said cost further comprises excluding at least a portion of the move from said insurance policy, such that said goods are not insured during said portion of the move, wherein said portion of the move is selected by the moving insurance server according to one or more of said category of transportation for said portion of the move or a geographical location of said portion of the move.

20. The method of claim 17, further comprising accepting said quote by the user through said user computer, including paying through said user computer to said moving insurance server; automatically notifying a mover server by said moving insurance server; after the move is performed, making a claim by the user through said user computer for at least a portion of the goods to said moving insurance server; and automatically calculating an amount of loss for said at least a portion of the goods by said moving insurance server.

21. The method of claim 20, wherein said list of goods comprises a set of images of said goods and wherein said making said claim further comprises selecting one or more images by the user through said user computer, and transmitting an indication of said selected image(s) to said moving insurance server.

22. The method of claim 21, wherein said making said claim further comprises uploading updated photographs of said portion of said goods to said user computer; transmitting said updated photographs to said moving insurance server; and automatically calculating said amount of loss at least partially according to said updated photographs by said moving insurance server.

23. The method of claim 21, wherein said making said claim further comprises requesting a report regarding loss or damage of said goods from a mover server by said moving insurance server; comparing said report from said mover server to said claim from said user computer; and automatically calculating said amount of loss at least partially according to said comparing.

24. The method of claim 14, further comprising recommending one or more movers to a user through said user computer before or after said receiving said request.

25. The method of claim 14, wherein said automatically calculating said cost comprises selecting an underwriter from a plurality of underwriters serving a geographical area by said moving insurance server at least partially according to cost.

26. The method of claim 1, wherein said user computer comprises a plurality of user computers, of which at least one user computer comprises a mobile communication device, and wherein optionally at least one of transmitting said start location and said end location, entering said list of goods or receiving said quote by said user computer, is performed separately on said mobile communication device.

27. The method of claim 26, wherein said mobile communication device is selected from the group consisting of a cellular telephone, a smart phone and a tablet computer.
